(19) United States
(12) Patent Application Publication
(10) Pub. No.: US 2004/0080684 A1
(43) Pub. Date: Apr. 29, 2004

(54) Color filter panel, manufacturing method thereof, and liquid crystal display including color filter panel

(76) Inventor: Soo-Guy Rho, Kyungki-do (KR)

Correspondence Address: F. Chau & Associates, LLP, Suite 501, 1900 Hempstead Turnpike, East Meadow, NY, 11554, US

(21) Appl. No.: 10/280,667

(22) Filed: Oct. 25, 2002

(51) Int. Cl. G02F 1/1335

(52) U.S. Cl. 349/106

(57) ABSTRACT

A transflective liquid crystal display includes upper and lower panels facing each other. On the lower panel, there formed a plurality of gate lines and a plurality of data lines intersecting each other to define pixel areas arranged in a matrix. A plurality of thin film transistors connected to the gate lines and the data lines and a plurality of pixel electrodes connected to the thin film transistors are also provided on the lower panel. Each pixel electrode includes a transparent electrode and a reflecting electrode with high reflectance having a transmitting window. A black matrix having apertures opposite the pixel areas and a plurality of red, green and blue color filters are formed on the upper panel. Each color filter includes thicker and thinner portions, and the thicker portion opposite the transmitting window.

### BACKGROUND OF THE INVENTION

(a) Field of the Invention

The present invention relates to a color filter panel, a manufacturing method thereof, and a liquid crystal display, especially a transflective liquid crystal display including a color filter panel.

(b) Description of Related Art

A liquid crystal display (“LCD”) is one of the most prevalent flat panel displays, which includes two panels having field-generating electrodes and a liquid crystal layer interposed therebetween and controls the transmittance of light passing through the liquid crystal layer by adjusting voltages applied to the electrodes to re-arrange liquid crystal molecules in the liquid crystal layer.

The most popular one among those LCDs is one having electrodes on the respective panels and having a plurality of thin film transistors (“TFTs”) for switching the voltages applied to the electrodes. Generally, the TFTs are provided on one of the two panels.

Such LCDs can be classified into two types, one of which is a transmissive type, displaying images by transmitting light from a specific light source called backlight through the liquid crystal layer, and the other of which is a reflective type, displaying images by reflecting external light such as natural light into the liquid crystal layer using a reflector of the LCD. Nowadays, a transflective type LCD operating in both a transmissive mode and a reflective mode is being developed.

On the other hand, a conventional LCD is equipped with red, green and blue color filters for realizing color displays. Color image is obtained by controlling the light transmittance passing through the respective red, green and blue color filters. The impression of colors among display devices is different due to the characteristics of the display devices, and the difference in the color impressions among the display devices is corrected or obtained by adjusting the thickness of the color filters or the density of the pigment distributed in the color filters.

The transflective type LCD shows non-uniform color reproducibility between in the transmissive mode and in the reflective mode since the number of the light passage through the color filters is different, which results in deterioration of the display characteristic. That is, the light in the transmissive mode passes the liquid crystal layer and the color filter only once to reach a user's eye, while the light in the reflective mode passes twice the liquid crystal layer and the color filter. Therefore, the impressions of the color in the two modes become different.

### SUMMARY OF THE INVENTION

A liquid crystal display is provided, which includes: a substrate; and a color filter formed on the substrate and having a position-dependent thickness.

The liquid crystal display preferably includes a first display area displaying images mainly using an external light and a second display area displaying images mainly using a light source provided therein. The thickness of the color filter in the first display area is preferably smaller than in the second display area.

According to an embodiment of the present invention, the color filter includes a first portion and a second portion having a thickness larger than the first portion, and the first portion surrounds the second portion.

Preferably, the color filter panel further includes a black matrix located near edges of the color filter and a third portion thicker than the first portion and located near edges of the color filter. The third portion of the color filter preferably overlaps the black matrix at leas in part.

According to an embodiment of the present invention, the color filter panel further includes a common electrode on the substrate.

A method of manufacturing a color filter panel for a liquid crystal display is provide, which includes: coating a photosensitive film comprising a pigment on a substrate; exposing the photosensitive film to light through at least one mask having a position-dependent transmissivity for light energy; and forming a plurality of color filters, each color filter having a position-dependent thickness by developing the photosensitive film.

According to an embodiment of the present invention, the at least one mask comprises first, second and third areas, and the transmissivity for light energy sequentially increases in the first area, in the second area and in the third area. The second area preferably includes a slit pattern or a lattice pattern.

According to an embodiment of the present invention, the photosensitive film is a negative photosensitive film, and further includes a monomer, a photopolymerization initiator, and a binder. Preferably, the insolubility of at least one portion of the photosensitive film after exposed to light ranges from 20% to 60%.

A transflective liquid crystal display is provided, which includes: a first panel having a color filter having a position-dependent thickness; and a second panel opposite the first panel, the second panel comprising a field-generating electrode including a transparent electrode and a reflecting electrode having an opening on the transparent electrode.

Preferably, the color filter comprises a first portion with a first thickness and a second portion with a second thickness larger than the first thickness, and the first portion is opposite the opening.

According to an embodiment of the present invention, the transparent electrode is located under the reflecting electrode, and the second panel further includes an insulating layer interposed between the transparent electrode and the reflecting electrode. The insulating layer preferably includes an unevenness pattern.

According to an embodiment of the present invention, the second panel further comprises a gate line, a data line and a thin film transistor electrically connected to the gate line, the data line and the transparent electrode.

### BRIEF DESCRIPTION OF THE DRAWINGS

The above and other objects and advantages of the present invention will become more apparent by describing preferred embodiments thereof in detail with reference to the accompanying drawings in which:

FIG. 1 is a layout view of a TFT array panel for a transflective LCD according to an embodiment of the present invention;

FIG. 2 is a sectional view of an LCD including the TFT array panel shown in FIG. 1 taken along the line II-II′;

FIGS. 3A-3C are sectional views of a color filter panel of a transflective LCD in the steps of a manufacturing method according to an embodiment of the present invention;

FIG. 4 is a graph showing the remaining thickness of photoresist films for red, green, and blue color filters as function of exposure energy flux;

FIG. 5 is a graph showing the transmittance of red, green, and blue color filters having different thicknesses as function of the wavelength of light;

FIG. 6 is a graph showing the color coordinates of red, green and blue color filters having different thicknesses;

FIGS. 7A, 8A, 9A, 10A, 11A and 12A are layout views of a TFT array panel of a transflective LCD in the steps of a manufacturing method according to an embodiment of the present invention;

FIG. 7B is a sectional view of the TFT array panel shown in FIG. 7A taken along the line VIIB-VIIB′;

FIG. 8B is a sectional view of the TFT array panel shown in FIG. 8A taken along the line VIIIB-VIIIB′, which is the next step of FIG. 7B;

FIG. 9B is a sectional view of the TFT array panel shown in FIG. 9A taken along the line IXB-IXB′, which is the next step of FIG. 8B;

FIG. 10B is a sectional view of the TFT array panel shown in FIG. 10A taken along the line XB-XB′, which is the next step of FIG. 9B;

FIG. 11B is a sectional view of the TFT array panel shown in FIG. 11A taken along the line XIB-XIB′, which is the next step of FIG. 10B; and

FIG. 12B is a sectional view of FIG. 12A along the line XIIB-XIIB′, which is the next step of FIG. 11B.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present. Then, a color filter panel, a transflective liquid crystal display, and a manufacturing method thereof according to embodiments of the present invention will be described with reference to the drawings.

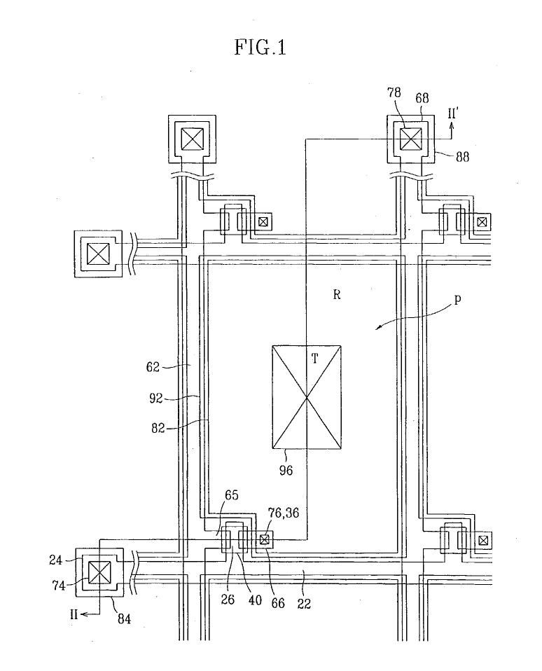

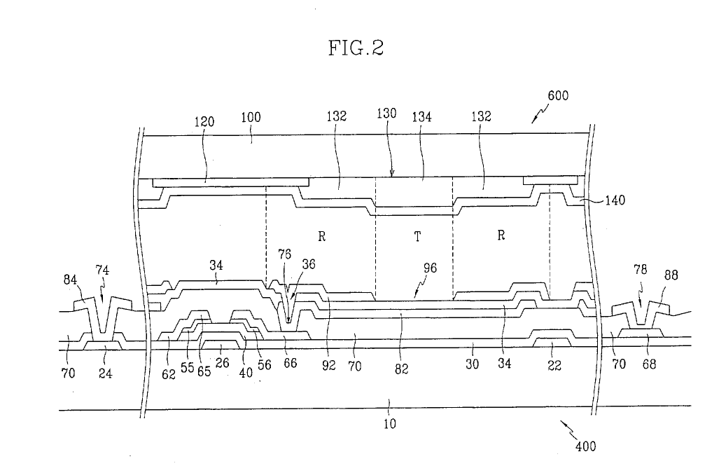

First, a structure of an LCD according to an embodiment of the present invention is described in detail with reference to FIGS. 1 and 2.

FIG. 1 is a layout view of a TFT array panel for a transflective LCD according to an embodiment of the present invention, and FIG. 2 is a sectional view of an LCD including the TFT array panel shown in FIG. 1 taken along the line II-II′.

As shown in FIGS. 1 and 2, an LCD according to an embodiment of the present invention includes lower and upper panels 400 and 600 facing each other and a liquid crystal layer interposed therebetween.

A plurality of gate lines 22 and a plurality of data lines 62, which intersect each other to define a plurality of pixel areas P arranged in a matrix, are formed on the lower panel 400. In each pixel area P, a TFT connected to the gate and the data lines 22 and 62, and a pixel electrode electrically connected to the TFT are provided. Each pixel electrode includes a transparent electrode 82 preferably made of transparent conductive film and a reflecting electrode 92 preferably made of reflective conductive film and having a transmitting window 96. An area occupied by the transmitting window 96 is referred to as a “transmissive area” T, while the remaining area of the pixel area P is referred to as a “reflective area” R hereinafter. In addition, areas of the lower panel corresponding to the transmissive area T and the reflective area R are referred to as the same names and numerals hereinafter.

A black matrix 120 having openings corresponding to the pixel areas P is formed on the upper panel 600, and red, green or blue color filters 130, which are covered with a common electrode 140, are formed on each pixel area P. For each of the red, green and blue color filters 130, a portion 132 located in the reflective area R has a thickness different from another portion 134 in the transmissive area. In this embodiment, the portion 132 in the transmissive area T has a larger thickness than the portion 134 in the reflective area R.

Here, the reflective area R is mainly used for displaying images utilizing the light reflected from the reflecting electrode 92, while the transmissive area T is mainly used for displaying images utilizing the light from a backlight, its own light source.

In the LCD according to this embodiment of the present invention, the images in the transmissive area T are generated by the light which passed through the color filter 130 only once, while those in the reflective area R are generated by the light which reaches the reflecting electrode 92 after passing through the color filter 130 once and then passes through the color filter 130 again after reflected by the reflecting electrode 92. Since the thickness of the color filter 130 in the reflective area R is smaller than that in the transmissive area T, two lights in the two areas T and R experience the color filter 130 almost in the same degree. Accordingly, the color reproduction properties for two areas T and R can be made to be equalized, thereby improving the display characteristic of the LCD.

Next, the structure of the lower panel 400 of the LCD according to the embodiment of the present invention is described in more detail.

The lower panel 400 includes an insulating substrate 10. A plurality of gate lines 22 extending substantially in a transverse direction are formed on the substrate 10. Each gate line 22 has a single-layered structure preferably made of a material having low resistivity such as silver, silver alloy, aluminum or aluminum alloy. Alternatively, each gate line 22 has a multiple-layered structure including a layer or layers made of the above listed materials, and preferably including at least one layer having good contact characteristic with another material. A portion 24 near one end of each gate line 22 transmits gate signals from an external device to the gate line 22, and a plurality of branches 26 of each gate line 22 serve as gate electrodes 26 of TFTs.

A gate-insulating layer 30 preferably made of silicon nitride (SiNx) or the like covers the gate lines 22.

A plurality of semiconductor islands 40 preferably made of hydrogenated amorphous silicon is formed on the gate insulating layer 30 opposite the gate electrode 26, and a plurality of pairs of ohmic contacts 55 and 56 preferably made of silicide or n+ hydrogenated amorphous silicon heavily doped with n type impurity are formed on the semiconductor islands 40. One 55 of each pair of ohmic contacts 55 and 56 is separated from the other 56 with respect to corresponding one of the gate lines 22.

A plurality of data lines 62 and a plurality of drain electrodes 66 are formed on the ohmic contacts 55 and 56 and the gate insulating layer 30. The data lines 62 and the drain electrodes 66 preferably include a conductive material having low resistivity such as aluminum or silver. The data lines 62 extend substantially in a longitudinal direction to intersect the gate lines 22. A plurality of branches 65 of the data lines 62 extend to the upper surfaces of the ones 55 of the respective pairs of the ohmic contacts 55 and 56 to form a plurality of source electrodes 65 of the TFTs. A portion 68 near one end of each data line 62 transmits data signals from an external source to the data line 62. The drain electrodes 66 of the TFTs are separated from the data lines 62 and located on the others 56 of the respective pairs of the ohmic contacts 55 and 56 opposite the source electrodes 65 with respect to the corresponding gate electrodes 26.

A passivation layer 70 preferably made of silicon nitride or organic material with good planarizability is formed on the data lines 62, the drain electrodes 66 and portions of the semiconductor islands 40 without being covered by the data lines 62 or the drain electrodes 66.

A plurality of contact holes 76 and 78 respectively exposing the drain electrodes 66 and the end portions 68 of the data lines 62 are formed through the passivation layer 70, and a plurality of other contact holes 74 exposing the end portions 24 of the gate lines 22 are provided in the passivation layer 70 and the gate-insulating layer 30.

A plurality of transparent electrodes 82 electrically connected to the drain electrodes 66 via the contact holes 76 are formed on the passivation layer 70 in the pixel areas P. In addition, a plurality of contact assistants 84 and 88 respectively connected to the end portions 24 of the gate lines 22 via the contact holes 74 and to the end portions 68 of the data lines 62 via the contact holes 78 are formed on the passivation layer 70. The transparent electrodes 82 and the contact assistants 84 and 88 are preferably made of transparent conductive material such as ITO (indium tin oxide) or IZO (indium zinc oxide).

An interlayer-insulating layer 34 is formed on the transparent electrodes 82. The interlayer insulating layer 34 is preferably made of silicon nitride, silicon oxide, or organic insulating material and has a plurality of contact holes 36 exposing the transparent electrodes 82 at least in part.

A plurality of reflecting electrodes 92 are formed on the interlayer insulating layer 34. Each reflecting electrode 92 is connected to the associated transparent electrode 82 via the appropriate contact hole 36 and has a transmitting window 96. The reflecting electrodes 92 are preferably made of a conductive film having high reflectance such as aluminum, aluminum alloy, silver, silver alloy, molybdenum, or molybdenum alloy. Here, it is preferable that the interlayer-insulating layer 34 has a rough top surface so as to make the surfaces of the reflecting electrodes 92 to become uneven, thereby increasing the reflectance of the reflecting electrodes 92. A pair of one of the reflecting electrodes 92 and the related transparent electrode 82 form a pixel electrode. The shapes of the transmitting windows 96 of the reflecting electrodes 92 are various, and the number of the transmitting windows 96 in a pixel area is not limited to one but may be equal to or more than two.

Each pixel electrode 82 and 92 overlaps one of the gate lines 22 called a previous gate line 22, which transmits a gate signal to TFTs of a pixel row adjacent thereto, to form a storage capacitor. If the storage capacitance of the storage capacitor is too small, another storage capacitor formed of a conductor made of the same layer as the gate lines 22 and the pixel electrode 82 and 92 or another conductor connected to the pixel electrode 82 and 92 can be added.

Each reflecting electrode 92 overlaps the data lines 62 adjacent thereto to maximize the aperture ratio of each pixel area P.

Now, a manufacturing method of a color filter panel and a TFT array panel of an LCD according to an embodiment of the present invention is described in detail.

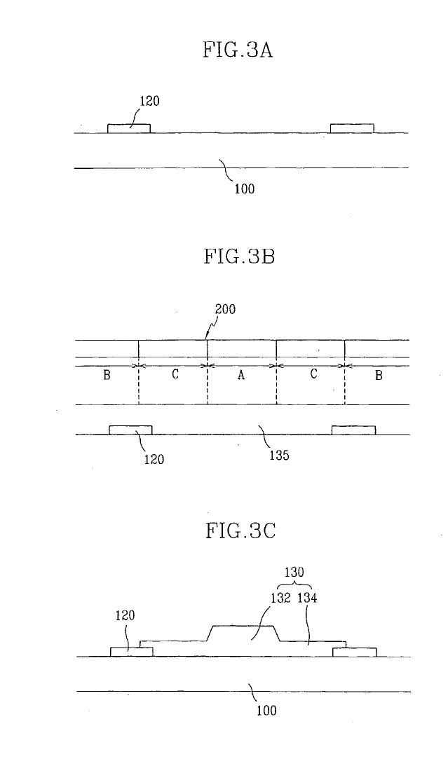

First, a manufacturing method of a color filter panel according to an embodiment of the present invention is described in detail with reference to FIGS. 3A-3D.

As shown in FIG. 3A, a black matrix 120 is formed by depositing the upper surface of an upper insulating substrate 100 with a material having good light-blocking characteristic and patterning the deposited material through photolithography using a photomask.

Then, as shown in FIG. 3B, a negative photosensitive film 135 is coated on the upper surface of the upper insulating substrate 100. The negative photosensitive film 135 is a water-insoluble dispersion solution containing a photopolymerizable photosensitive composition including photopolymerization initiators, monomers, binders, etc., and one of red, green and blue pigments. Thereafter, the photosensitive film 135 is exposed to light through a mask 200 which can vary the energy absorbed by the photosensitive film 135 for different areas A, B and C.

The photopolymerization of the exposed portions of the negative photosensitive film 135 results in insolubility of the portions for an alkali developing solution. More specifically, the photopolymerization initiators are activated to free-radical initiators upon exposure to the light, the free-radical initiators induce the monomers to generate free-radical monomers, and then the radical monomers are polymerized to polymers through chain-reaction polymerization. As a result, the exposed portions of the photosensitive film 135 become insoluble.

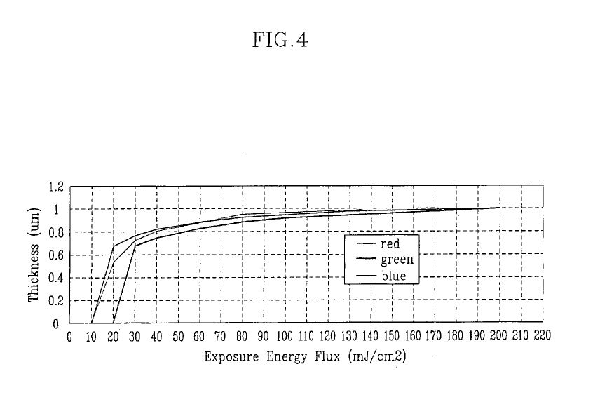

In this embodiment, the thickness of the photosensitive film 135 after developed is different depending on the position by differentiating the degrees of the insolubility of the photosensitive film 135 to the developing solution depending on the position, using a mask, which can vary the exposure energy absorbed by the photosensitive film 135. This is to be described in detail with reference to FIG. 4.

FIG. 4 is a graph showing the thickness of remaining portions of photosensitive films for red, green and blue color filters as function of the exposure energy flux.

The curves shown in FIG. 4 illustrate small variation of the thickness of the remaining portions for the exposure energy flux in a range of 30-170 mJ/cm², while illustrate drastic change for the exposure energy flux in a range of 10-30 mJ/cm². That is, the steep variation of the dissolubility of the binders to the developing solution depending on the exposure energy causes the drastic change of the degree of the photopolymerization in the latter range. This means that the thickness of the remaining portions of the photosensitive films can be easily adjusted by controlling the exposure energy flux in this range. Changing the kinds of the monomers and the photopolymerization initiators and the mixture ratio thereof can control the slope of the thickness of the remaining portions as function of the exposure energy flux.

Here, the initial energy is almost fully transferred to portions of the photosensitive film 135 in the area A, while the initial energy is almost fully blocked not to reach portions in the area B. Portions of the photosensitive film 135 in the area C receive part of the initial energy, flux of which ranges from 10 mJ/cm² to 30 mJ/cm².

The area C can be obtained by using a mask 200 having a translucent portion with a slit pattern or a lattice pattern. When using a slit pattern, it is preferable that the width of the slits or the distance between the slits is smaller than the resolution of an exposer used in this step. Alternatively, the mask 200 with a translucent portion is obtained by making the thickness of a layer thereon to be different depending on the position or by using a plurality of layers having different transmissivity.

In this embodiment, when exposed to light through the mask 200, the portions in the area C are polymerized in part, preferably 20-60%.

The photosensitive film 135 is developed using an alkali solution. Then, as shown in FIG. 3C, a color filter 130 having two portions 132 and 134 with different thickness is obtained.

An array of color filters is obtained by repeatedly performing these steps for red, green and blue color filters.

Finally, a common electrode 140 preferably made of a transparent conductive material such as ITO and IZO is formed on the color filter 130 and the black matrix 120.

Although this embodiment of the present invention uses the single mask 200 which can give the different exposure energies depending on the positions, another embodiment uses two or more masks, respective masks giving different exposure energies.

According to another embodiment of the present invention, edge portions of the color filter 130 overlapping the black matrix 120 has substantially the same thickness as the portion 132, as shown in FIG. 3D. That is, the area A is located at a position between the areas B and C as well as at a position corresponding to a transmitting window. This makes the thickness of the color filter 135 in the area C to be uniform, and prevents the edges of the color filter 132 from being detached when developing.

Next, it will be described the transmittance and the color coordinates of red, green and blue color filters with different thickness between in a transmissive area T and in a reflective area R.

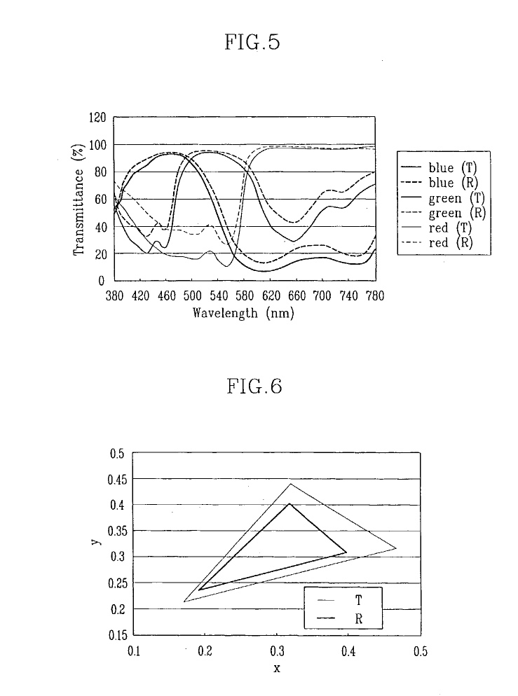

FIG. 5 is a graph showing the transmittance of red, green and blue color filters having difference thickness according to an embodiment of the present invention as function of the wavelength of incident light for a transmissive area T and a reflective area R, and FIG. 6 is a graph showing the color coordinates of red, green and blue color filters having difference thickness according to the embodiment of the present invention.

The thickness of the color filters was about 0.8 microns and 0.4 microns in the transmissive area T and the reflective area R, respectively. The color reproducibility obtained by adjusting the thickness of the color filters in the range of about 0.2-2 microns was about 16%. In FIG. 5, the solid lines indicate the transmittances of the red, green and blue color filters in the transmissive area T, while the dotted lines indicate those in the reflective area R. In FIG. 6, “T” indicates the color coordinates in the transmissive area T, and “R” indicates those in the reflective area R.

As shown in FIG. 5, it was observed that the transmittance of each color filter was different in the transmissive area T and in the reflective area R, and this is considered to be resulted from the thickness difference in the two area T and R. Accordingly, the appropriate adjustment of the color filters enables to realize the different color reproducibility in the areas T and R.

As shown in FIG. 6, the color reproducibility in the transmissive area T is about 16%, while that in the reflective area is about 8%.

The color reproducibility of a display device based on the NTSC (National Television System Committee) is defined as the ratio of the area of the triangle including segments connecting the monochrome points for red, green and blue colors of the display in the CIE (Commission Internationale de l'Eclairage) color coordinate system with respect to a standard area suggested by the NTSC.

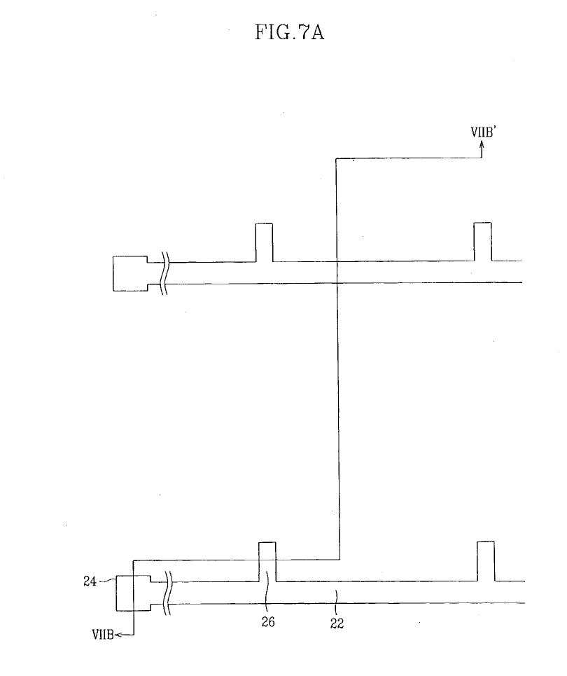

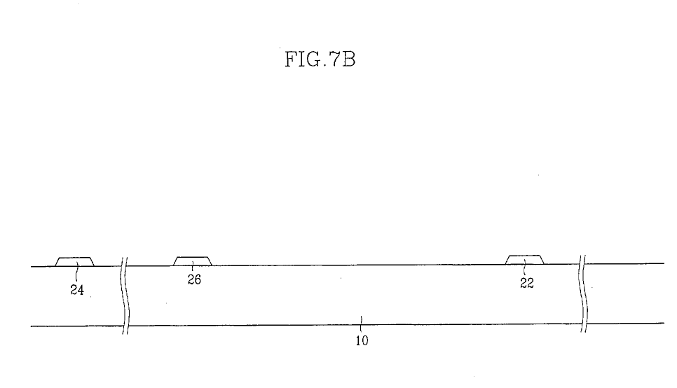

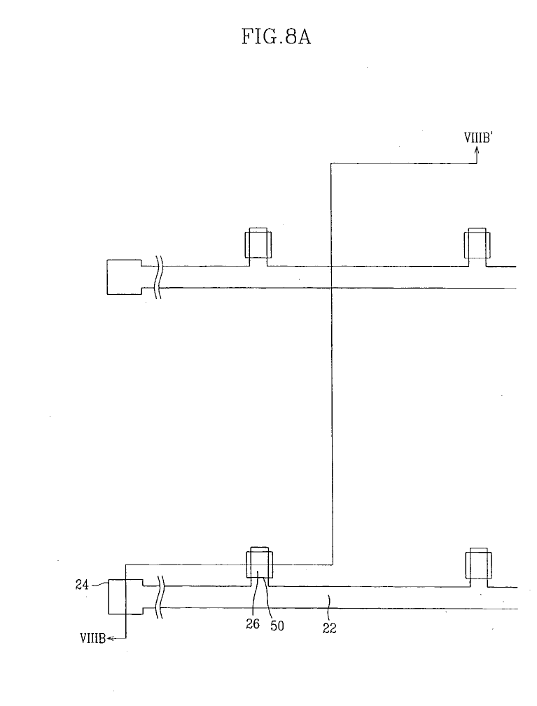

Now, a manufacturing method of a TFT array panel according to an embodiment of the present invention is described in detail with reference to FIGS. 7A-12B as well as FIGS. 1 and 2.

First, as shown in FIGS. 7A and 7B, a conductive material having low resistivity is deposited on an upper surface of a lower glass substrate 10 and patterned to form a plurality of gate lines 22 substantially extending in a transverse direction and including a plurality of gate electrodes.

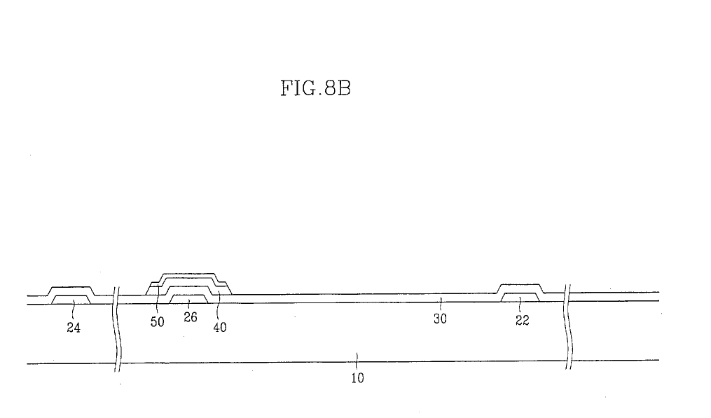

Next, triple layers of a gate insulating layer 30 preferably made of silicon nitride, a semiconductor layer preferably made of amorphous silicon, and a doped amorphous silicon layer are deposited in sequence. The upper two layers of the semiconductor layer and the doped amorphous silicon layer are patterned in sequence using a photomask to form a plurality of semiconductor islands 40 and a plurality of doped amorphous silicon islands 50 thereon opposite the gate electrode 24, as shown in FIGS. 8A and 8B.

Subsequently, a conductive layer is deposited and patterned using photolithography to form a plurality of data lines 62 intersecting the gate lines 22 and a plurality of drain electrodes 62. Each data line 62 includes a plurality of source electrodes 65 extending to an upper surface of the corresponding doped amorphous silicon islands 50. The drain electrodes 66 separated from the data lines 62 and opposite to the related source electrodes 65 with respect to the gate electrodes 26.

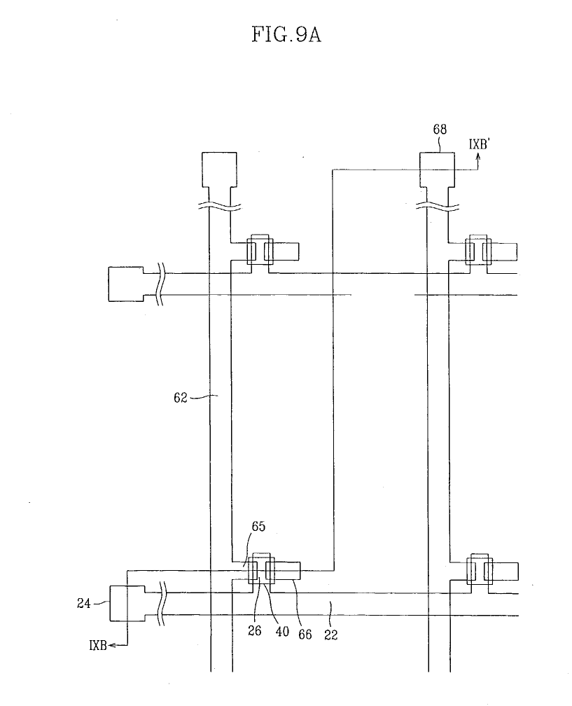

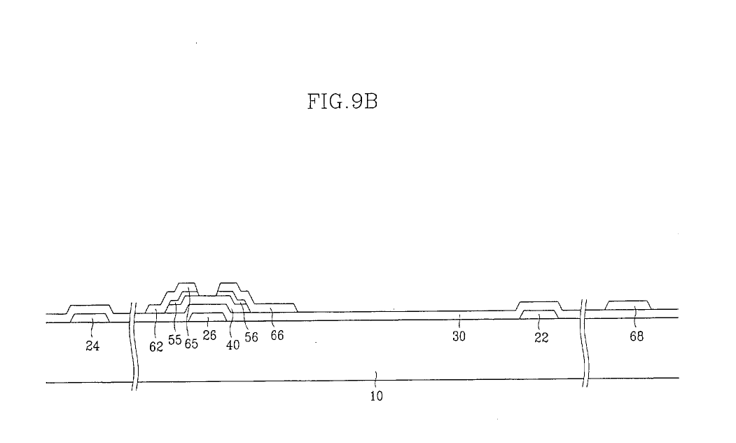

Thereafter, as shown in FIGS. 9A and 9B, portions of the doped amorphous silicon islands 50, which are not covered with the data lines 62 and the drain electrodes 66, are removed so that each doped amorphous silicon island 50 is divided into two ohmic contacts 55 and 56 with respect to the gate electrode 26, and portions of the semiconductor island 40 under the removed portions of the doped amorphous silicon island 50 are exposed. It is preferable to perform oxygen plasma treatment to stabilize the surface of the exposed portions of the semiconductor islands 40.

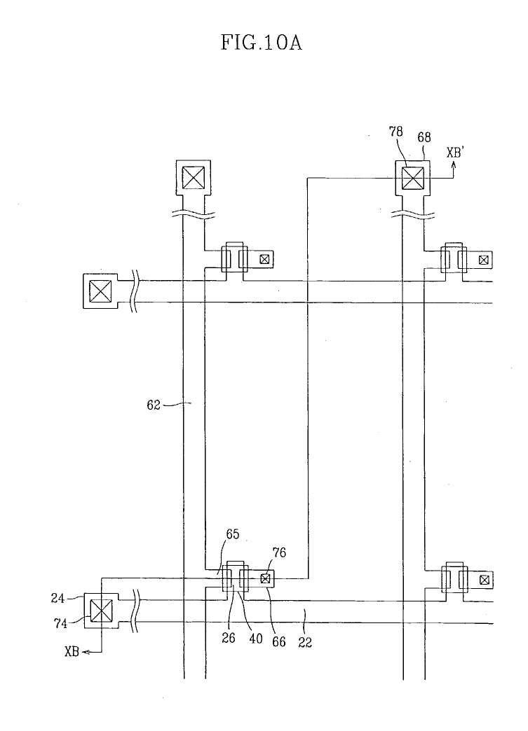

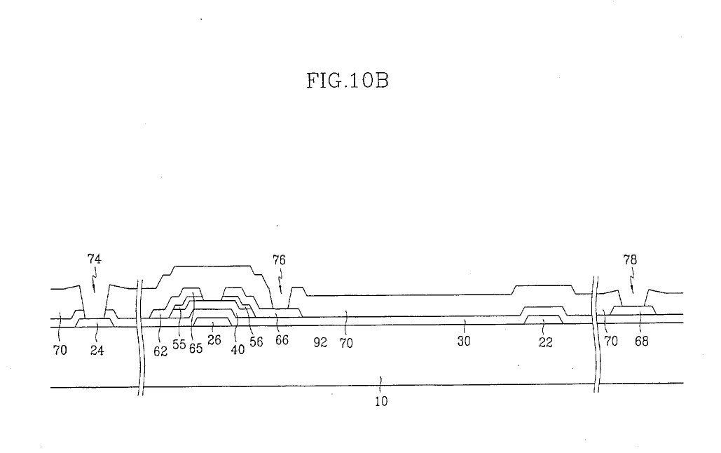

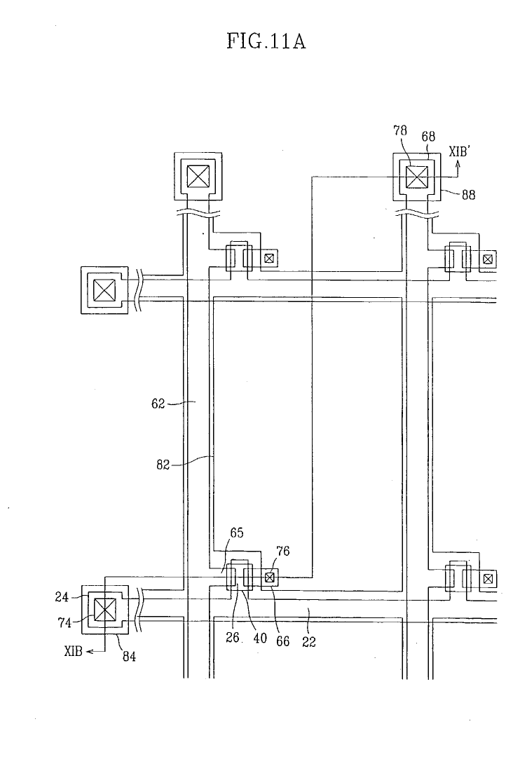

Succeedingly, a passivation layer 70 is formed by deposition of organic material with low dielectric constant and good planarizability or insulating material such as silicon nitride. Thereafter, as shown in FIGS. 10A and 10B, the passivation layer 70 and the gate insulating layer 30 is patterned by dry etch using photolithography to form a plurality of contact holes 74, 76 and 78 exposing end portions 24 of the gate lines 22, the drain electrodes 66 and end portions 68 of the data lines 62, respectively.

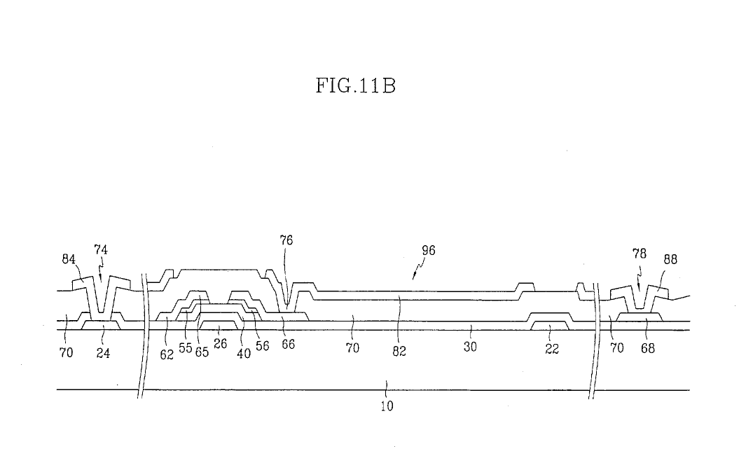

Subsequently, as shown in FIGS. 11A and 11B, an ITO layer or an IZO layer is deposited and patterned using a photomask to form a plurality of transparent electrodes 82 connected to the associated drain electrodes 66 via the contact holes 76, and a plurality of contact assistants 86 and 88 connected to the end portions 24 of the gate lines 22 and the end portions 68 of the data lines 62 via the contact holes 74 and 78, respectively.

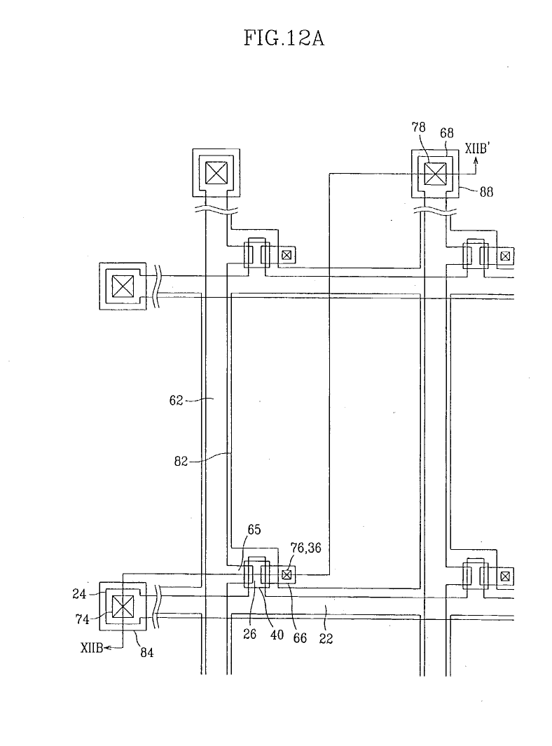

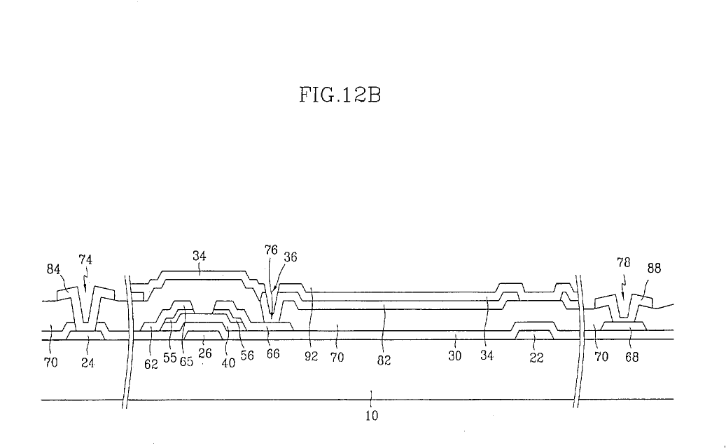

Now, as shown in FIGS. 12A and 12B, an interlayer insulating layer 34 having a plurality of contact holes 36 exposing the transparent electrodes 82 is formed by depositing organic insulating material and patterning it using photolithography. An unevenness pattern is preferably provided on the interlayer-insulating layer 34.

Finally, as shown in FIGS. 1 and 2, a plurality of reflecting electrodes 92, each having a transmitting window 96, are formed by depositing and patterning a conductive layer with high reflectance such as aluminum, silver, or molybdenum. The reflecting electrode 92 preferably has embossment due to the unevenness pattern of the underlying interlayer insulating layer 34, which enhances reflectance of the reflecting electrode 92.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A color filter panel for a liquid crystal display comprising:
a substrate; and
a color filter formed on the substrate and having a position dependent thickness.

2. The color filter panel of claim 1, wherein the liquid crystal display includes a first display area displaying images mainly using an external light and a second display area displaying images mainly using a light source provided therein.

3. The color filter panel of claim 2, wherein the thickness of the color filter in the first display area is smaller than in the second display area.

4. The color filter panel of claim 1, wherein the color filter comprises a first portion and a second portion having a thickness larger than the first portion, and the first portion surrounds the second portion.

5. The color filter panel of claim 4, further comprising a black matrix located near edges of the color filter.

6. The color filter panel of claim 5, wherein the color filter further comprises a third portion thicker than the first portion and located near edges of the color filter.

7. The color filter panel of claim 6, wherein the third portion of the color filter overlaps the black matrix at leas in part.

8. The color filter panel of claim 1, further comprising a common electrode on the substrate.

9. A method of manufacturing a color filter panel for a liquid crystal display, the method comprising:
coating a photosensitive film comprising a pigment on a substrate;
exposing the photosensitive film to light through at least one mask having a position-dependent transmissivity for light energy; and
forming a plurality of color filters, each color filter having a position-dependent thickness by developing the photosensitive film.

10. The method of claim 9, wherein the at least one mask comprises first, second and third areas, and the transmissivity for light energy sequentially increases in the first area, in the second area and in the third area.

11. The method of claim 10, wherein the second area comprises a slit pattern or a lattice pattern.

12. The method of claim 9, wherein the photosensitive film is a negative photosensitive film.

13. The method of claim 12, wherein the photosensitive film further comprises a monomer, a photopolymerization initiator, and a binder.

14. The method of claim 13, wherein the insolubility of at least one portion of the photosensitive film after exposed to light ranges from 20% to 60%.

15. A transflective liquid crystal display comprising:
a first panel having a color filter having a position-dependent thickness; and
a second panel opposite the first panel, the second panel comprising field-generating electrode including a transparent electrode and a reflecting electrode having an opening on the transparent electrode.

16. The transflective liquid crystal display of claim 15, wherein the color filter comprises a first portion with a first thickness and a second portion with a second thickness larger than the first thickness, and the first portion is opposite the opening.

17. The transflective liquid crystal display of claim 16, wherein the transparent electrode is located under the reflecting electrode.

18. The transflective liquid crystal display of claim 17, wherein the second panel further comprises an insulating layer interposed between the transparent electrode and the reflecting electrode.

19. The transflective liquid crystal display of claim 18, wherein the insulating layer comprises an unevenness pattern, and the reflecting electrode has embossment.

20. The transflective liquid crystal display of claim 15, wherein the second panel further comprises a gate line, a data line and a thin film transistor electrically connected to the gate line, the data line and the transparent electrode.
